(19) United States
(12) Patent Application Publication
(10) Pub. No.: US 2018/0049024 A1
(43) Pub. Date: Feb. 15, 2018

(54) User Equipment Registration Recovery Upon Core Node Failure

(71) Applicant: Telefonaktiebolaget LM Ericsson (publ), Stockholm (SE)

(72) Inventors: Paul Schliwa-Bertling, Ljungsbro (SE); Håkan Palm, Växjö (SE); Peter Werner, Linköping (SE); Emre Yavuz, Stockholm (SE)

(21) Appl. No.: 15/556,021

(22) PCT Filed: Mar. 9, 2016
(86) PCT No.: PCT/SE2016/050188

§ 371 Date: Sep. 6, 2017

Related U.S. Application Data
(60) Provisional application No. 62/130,173, filed on Mar. 9, 2015.

(51) Int. Cl. H04W 8/30; H04W 24/04; H04W 8/20

(52) U.S. Cl. CPC H04W 8/30; H04W 8/20; H04W 24/04

(57) ABSTRACT

In one aspect, a network node determines there is a loss of user context information for one or more user equipments and signals to radio base stations connected to the network node to notify the one or more user equipments of the loss of user context information in broadcast system information. A radio base station transmits an information element indicating the loss of user context information in broadcast system information. A user equipment receives the information element in broadcast system information and detaches and reattaches to the network node upon a determination that the network node indicated by the information element matches a network node in registration information stored at the user equipment.

### TECHNICAL FIELD

The present invention generally relates to wireless communication networks, and particularly relates to registration of wireless devices with core network entities.

### BACKGROUND

An increasing number of machines or other autonomous devices communicate with each other (or with an application server) without human interaction over cellular networks. A typical scenario is to have sensors sending measurements infrequently, where each of the transmissions consists of only small amounts of data. This type of communication is referred to as machine to machine (M2M) communications or machine-type communication (MTC). Devices in cellular systems (such as Evolved Universal Terrestrial Radio Access or E-UTRA) are often battery driven and the power consumption is therefore an important factor. Sensors and other similar devices may reside in remote locations and the number of deployed devices could be so large that it would be practically infeasible to replace the batteries of such devices. Thus, it is important to reduce the amount of power consumption.

An existing means to reduce the battery power consumption is to use discontinuous reception (DRX), a feature in which the device receiver is switched off except during configured intervals. Currently the longest specified DRX cycle length is 2.56 seconds for E-UTRA. However, it would be beneficial to extend the DRX cycles beyond currently specified values to reduce the battery power consumption further especially for such (MTC type of) devices. Extended DRX cycles naturally cause larger delays to reach the user equipment (UE) in the downlink, however this is typically not considered a problem due to the delay insensitive traffic on such devices.

MTC devices can sometimes be placed in challenging locations, for which E-UTRA network deployments were not dimensioned for full coverage. For example, smart meters are often placed in building basements and are sometimes even contained in metal enclosures. Similarly, devices may be located in rural and isolated areas to address smart agriculture scenarios. As a consequence, long-range coverage extensions are defined so that the coverage for (low data-rate) MTC devices can be extended.

To enhance the radio coverage and reduce the power consumption for these MTC devices, there are ongoing efforts in the wireless community. For the former, it is essential to reduce the signaling overhead since repetition is one of the main techniques for those UEs to access the network, e.g. ensuring that the message sizes are kept small. While for the latter, it is essential to minimize the UE activity periods, e.g. by introducing extended DRX cycles.

The Evolved UMTS Terrestrial Radio Access Network (E-UTRAN), standardized by members of the 3rd Generation Partnership Project (3GPP), includes radio base stations called enhanced NodeBs (eNBs or eNodeBs), providing the E-UTRA user plane and control plane protocol terminations towards the user equipment or UE. The eNBs are interconnected with each other using the X2 interface. The eNBs are also connected using the S1 interface to the EPC (Evolved Packet Core), more specifically to the MME (Mobility Management Entity) by means of the S1-MME interface and to the Serving Gateway (S-GW) by means of the S1-U interface. The S1 interface supports a many-to-many relation between MMEs/S-GWs and eNBs. A simplified view of the E-UTRAN architecture is illustrated in FIG. 1.

The eNB hosts functionalities such as Radio Resource Management (RRM), radio bearer control, admission control, header compression of user plane data towards serving gateway, and/or routing of user plane data towards the serving gateway. The MME is the control node that processes the signaling between the UE and the CN (core network). Significant functions of the MME are related to connection management and bearer management, which are handled via Non Access Stratum (NAS) protocols. The S-GW is the anchor point for UE mobility, and also includes other functionalities such as temporary DL (downlink) data buffering while the UE is being paged, packet routing and forwarding to the right eNB, and/or gathering of information for charging and lawful interception. The PDN Gateway (P-GW, not shown in FIG. 1) is the node responsible for UE IP address allocation, as well as Quality of Service (QoS) enforcement (as further discussed below). The reader is referred to 3GPP TS 36.300 and the references therein for further details of functionalities of the different nodes.

FIG. 2 gives a summary of the functionalities of the different nodes, and the reader is referred to the 3GPP document “Evolved Universal Terrestrial Radio Access (E-UTRA) and Evolved Universal Terrestrial Radio Access Network (E-UTRAN); Overall Description; Stage 2,” 3GPP TS 36.300, v. 11.3.0 (September 2012), available at 3gpp.org, and the references therein for the details of the functionalities of the different nodes. In FIG. 2, the boxes labeled “eNB,” “MME,” “S-GW,” and “P-GW” depict the logical nodes, the unshaded white boxes within the larger boxes depict the functional entities of the control plane, and the shaded boxes within the box labeled “eNB” depict the radio protocol layers.

In E-UTRA, a UE attached to the network has a UE context in the MME, see 3GPP TS 23.401. In this UE context, data essential for the communication is stored. One example is the temporary mobile subscriber identity (S-TMSI), which is used to address the UE over the radio interface. Another example is the tracking area identity (TAI) List, which describes the set of cells, one of which were UE is located. In case of an MME failure, user context information such as the UE context and data like S-TMSI and TAI List is lost. Section 5.6.2.2.2 of 3GPP TS 24.301 defines the following procedure to take place as a recovery measure, to reach and notify the UE of terminating call/data.

Paging for Evolved Packet System (EPS) services using International Mobile Subscriber Identity (IMSI) is an abnormal procedure used for error recovery in the network. The network may initiate paging for EPS services using IMSI with core network (CN) domain indicator set to “PS” if the S-TMSI is not available due to a network failure (see example in FIG. 3).

In S1 mode, to initiate the procedure, the EPS Mobility Management (EMM) entity in the network requests the lower layer to start paging. If the TAI list is not available due to a network failure, the network may perform the paging within all tracking areas served by the MME (see 3GPP TS 36.331 and 3GPP TS 36.413). When a UE receives a page for EPS services using IMSI from the network before a UE initiated EMM specific procedure has been completed, the UE then aborts the EMM specific procedure and proceeds according to the description in subclause 5.6.2.2.2 of 3GPP TS 24.301. Upon reception of paging for EPS services using IMSI, the UE shall stop timer T3346, if it is running, locally deactivate any EPS bearer context(s) and locally detach from EPS. Additionally, the UE shall delete the following parameters: last visited registered TAI, TAI list, Globally Unique Temporary ID (GUTI) and Key Selection Identifier Access Security Management Entity (KSIASME). The UE shall set the EPS update status to EU2 NOT UPDATED and change the state to EMM-DEREGISTERED. The UE shall stop all timers T3396 that are running.

If A/Gb mode or Iu mode is supported by the UE, the UE shall, in addition, handle the General Packet Radio System (GPRS) Mobility Management (GMM) parameters, GMM state, GPRS update status, P-TMSI, P-TMSI signature, RAI, and GPRS ciphering key sequence number as specified in 3GPP TS 24.008 for the case when a paging for GPRS services using IMSI is received.

After performing the local detach, the UE shall then perform an attach procedure as described in subclause 5.5.1.2 of 3GPP TS 24.301. If the UE is operating in CS/PS mode 1 or CS/PS mode 2 of operation, then the UE shall perform a combined attach procedure as described in subclause 5.5.1.3. In some cases, user interaction can be required, thus the UE cannot activate the dedicated bearer context(s) automatically. Also, the UE does not respond to the paging except with the attach request, hence timer T3413 in the network is not used when paging with IMSI.

It is recognized herein that the procedure described above results in a massive paging load over a large number of cells (“all tracking areas served by the MME”) using the IMSI that requires more encoding bits in the paging message compared to a paging message where S-TMSI is used. The sum of these impacts would consume substantial radio resources used for paging, and even increase the risk of congestion.

For UEs that are in a position that requires coverage enhancement techniques, the paging message will be repeated several hundreds of times for successful UE reception. The procedure described above would introduce even higher risk of radio resource congestion. Given that the information that a particular UE may support and need coverage enhancement techniques is lost at the MME failure, the procedure described above will fail as such devices will not be reached.

In this case, UE-specific DRX cycle lengths (previously negotiated between the MME and the UE) are lost in the network due to the MME failure. As a result, the network may not be able to reach the UE until next time UE triggers registration procedure. This will disable the recovery procedure described above.

### SUMMARY

Embodiments of the present invention comprise apparatuses and methods for registration recovery of wireless devices upon a loss of user context information by a network node for which the devices are registered. For example, an MME may lose user context information, such as S-TMSIs, TAI lists, DRX cycle length or use of coverage enhancement techniques. Of course, lost user context information may include other data, including but not limited to, coverage level, etc. The loss of user context information may be caused by a failure of the MME.

According to some embodiments, the MME determines there is a loss of user context information for wireless devices such as UEs, and signals to radio base stations (e.g., eNBs) connected, or communicatively coupled, to the MME to notify the UEs of the loss of user context information in, for example, broadcast system information (SIB). The MME failure is indicated to radio eNBs connected to the MME using a procedure, message or information element. For example, a new information element may be transmitted in S1 Management procedures, such as in the S1 messages S1 SETUP RESPONSE and/or MME CONFIGURATION UPDATE.

As for the eNB, the eNB determines that the MME has lost user context information for UEs registered to the network node. In response to the determination, an information element indicating the loss of user context information is transmitted in broadcast system information. For instance, the connected eNBs will start to transmit a new information element in broadcast system information identifying the affected/failed MMES. The information element may contain: alt1 (List of) Global Unique Mobility Management Entity Identifiers (GUMMEIs) of the Failure MME; alt2 (List of) MME Identifiers (MMEIs) of the Failure MME and/or alt3 (List of) MME codes (MMECs) of the failure MME.

UEs in a cell of the connected eNB will be triggered to receive broadcast system information in the cell. This can be achieved by transmitting paging messages in all cells of the connected eNB, indicating that all UEs (i.e. not only UEs addressed in the paging message) shall start to receive broadcast system information. This can also be achieved by UEs regularly (i.e. according to a preconfigured time interval) and autonomously starting to receive broadcast system information in the cell.

A UE located in the cell controlled by the connected eNBs receives the new information element in broadcast system information and compares to its locally stored information identifying its registered MME (Globally Unique Temporary ID (GUTI) that contains the MMEC). In the case there is a match (which means the UE is registered to the failed MME), the UE detaches (and releases the bearers locally) and re-attaches to the network (3), which means a new UE context (including S-TMSI, TAI List, DRX cycle length, use of coverage enhancement techniques, etc.) is created in the MME.

In some embodiments, to make sure the UE does not detach and re-attach multiple times as triggered by the same MME failure, a counter (sequence number) can be added to the S1 sequence management procedure (1) and the broadcast system information (2). This counter is stepped by one at MME failure. When the UE triggers detach and re-attach (4), the UE memorizes the counter value, and will trigger yet another detach/re-attach only in case the counter value broadcast in system information is different from the UE-stored count value.

The discussions of the solutions are based on E-UTRA; however, these aspects can also be considered valid for other technologies.

According to some embodiments, a method, in a radio base station connected to a network node in a wireless communication network, for indicating a loss of user context information stored by the network node, includes determining that the network node has lost user context information for one or more user equipments registered to the network node. The method also includes, in response to said determining, transmitting an information element indicating the loss of user context information in broadcast system information.

According to some embodiments, a method, in a user equipment registered to a network node in a wireless communication network, for reattaching to the network node upon loss of user context information stored by the network node, includes receiving an information element in broadcast system information from a radio base station connected to the network node, the information element indicating the network node has lost user context information. The method also includes comparing the network node indicated by the information element to information stored on the user equipment that identifies the network node to which the user equipment is registered. The method further includes, responsive to a determination that the network node indicated by the information element matches the network node in the stored information, detaching and reattaching to the network node.

According to some embodiments, a method, in a network node storing user context information for user equipments for which the network node is registered, for recreating new user context information upon a loss of user context information, includes determining there is a loss of user context information for one or more user equipments and signaling to radio base stations connected to the network node to notify the one or more user equipments of the loss of user context information in broadcast system information.

According to some embodiments, a radio base station connected to a network node in a wireless communication network and configured to indicate a loss of user context information stored by the network node, includes a transceiver circuit and a processing circuit operatively connected to the transceiver circuit. The processing circuit is configured to determine that the network node has lost user context information for one or more user equipments registered to the network node, and, in response to the determination, transmit, via the transceiver circuit, an information element indicating the loss of user context information in broadcast system information.

According to some embodiments, a user equipment registered to a network node in a wireless communication network and configured to reattach to the network node upon loss of user context information stored by the network node, includes a transceiver circuit and a processing circuit operatively connected to the transceiver circuit. The processing circuit is configured to receive an information element in broadcast system information from a radio base station connected to the network node, the information element indicating the network node has lost user context information. The processing circuit is configured to compare the network node indicated by the information element to information stored on the user equipment that identifies the network node to which the user equipment is registered, and, responsive to a determination that the network node indicated by the information element matches the network node in the stored information, initiate detachment and reattachment to the network node.

According to some embodiments, a network node storing user context information for user equipments for which the network node is registered and configured to recreate new user context information upon a loss of user context information, includes a communication interface circuit and a processing circuit operatively connected to the communication interface circuit. The processing circuit is configured to determine there is a loss of user context information for one or more user equipments and signal, via the communication interface circuit, to radio base stations connected to the network node to notify the one or more user equipments of the loss of user context information in broadcast system information.

Variations of the above-described methods, as well as corresponding apparatuses, computer program products, computer readable medium and functional implementations are described in detail below.

Of course, the present invention is not limited to the above features and advantages. Those of ordinary skill in the art will recognize additional features and advantages upon reading the following detailed description, and upon viewing the accompanying drawings.

### BRIEF DESCRIPTION OF THE DRAWINGS

FIG. 1 is a diagram of a simplified view of E-UTRAN architecture.

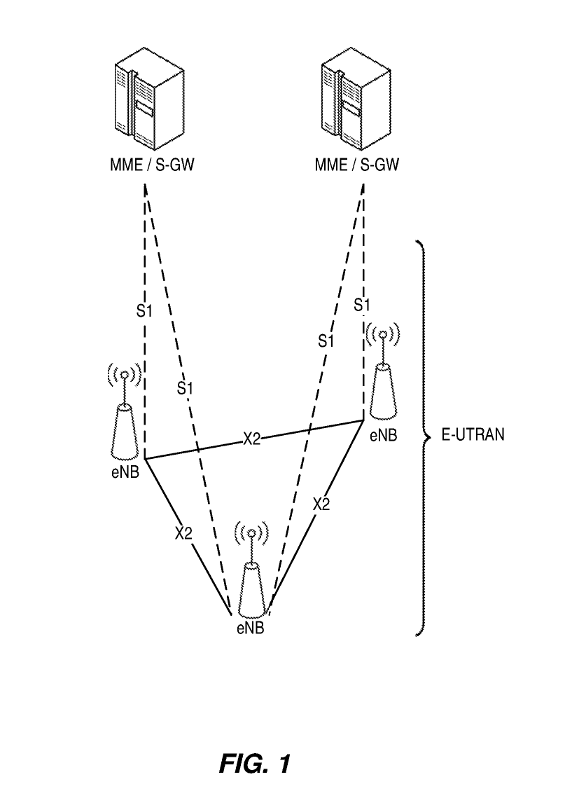

FIG. 2 illustrates functionalities of the different nodes in the E-UTRAN architecture.

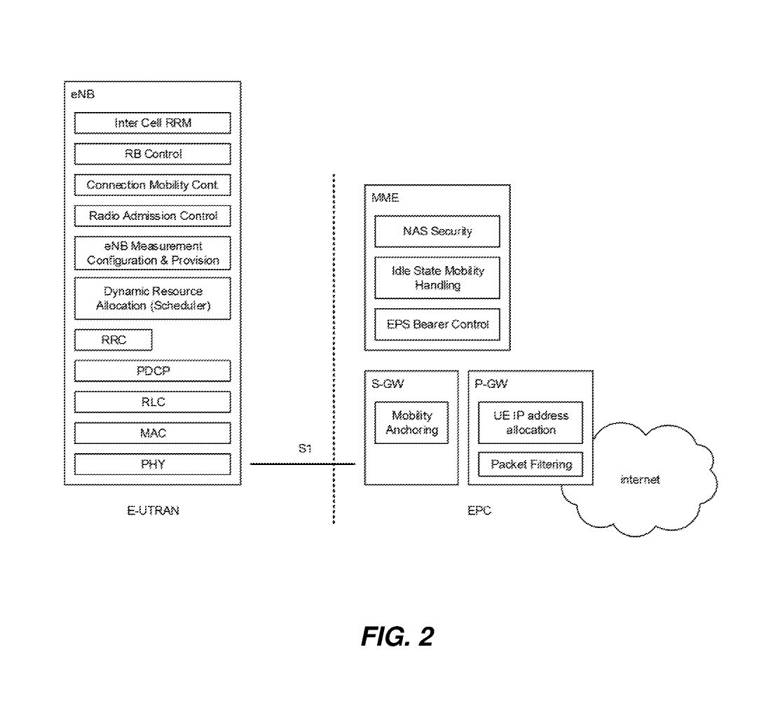

FIG. 3 illustrates paging for an attachment request.

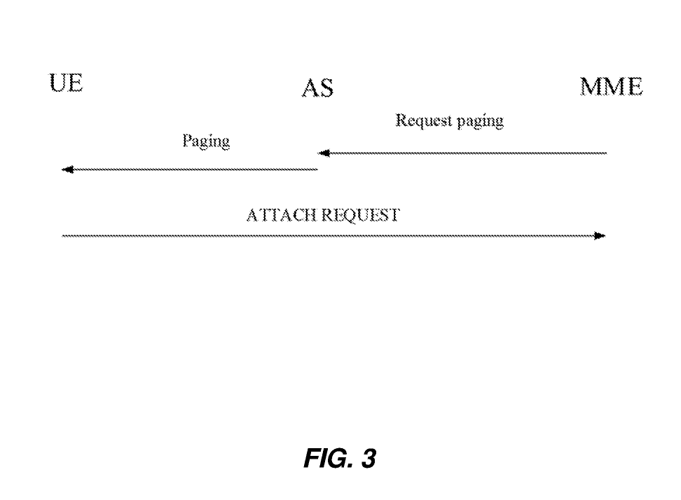

FIG. 4 illustrates a block diagram of a network node configured to recreate new user context information upon a loss of user context information, according to some embodiments.

FIG. 5 illustrates a block diagram of a radio base station configured to indicate a loss of user context information stored by the network node, according to some embodiments.

FIG. 6 illustrates a block diagram of a user equipment configured to reattach and recover registration to the network node upon loss of user context information stored by the network node, according to some embodiments.

FIG. 7 illustrates a method for recreating new user context information upon a loss of user context information, according to some embodiments.

FIG. 8 illustrates a method for indicating a loss of user context information stored by the network node, according to some embodiments.

FIG. 9 illustrates a method for reattaching to the network node upon loss of user context information stored by the network node, according to some embodiments.

FIG. 10 illustrates an overview of a network performing registration recovery of user equipments upon loss of user context information by a network node, according to some embodiments.

FIG. 11 illustrates information elements in an example S1 SETUP RESPONSE message, according to some embodiments.

FIG. 12 illustrates information elements in an example MME CONFIGURATION UPDATE message, according to some embodiments.

FIG. 13 illustrates an example functional implementation of recreating new user context information upon a loss of user context information, according to some embodiments.

FIG. 14 illustrates an example functional implementation of indicating a loss of user context information stored by the network node, according to some embodiments.

FIG. 15 illustrates an example functional implementation of indicating a loss of user context information stored by the network node, according to some embodiments.

### DETAILED DESCRIPTION

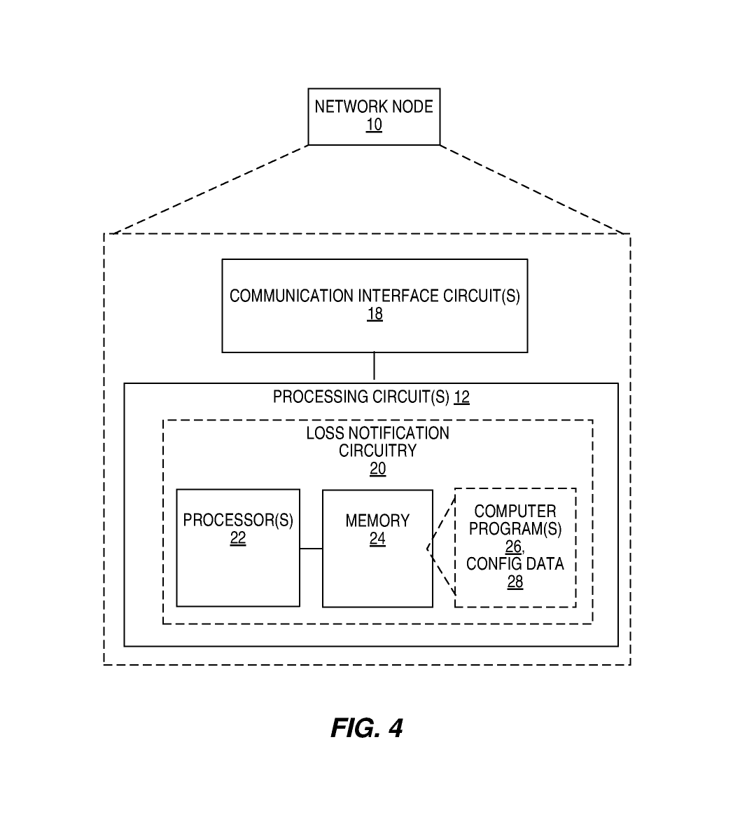

FIG. 4 illustrates a diagram of a network node 10, according to some embodiments. The network node 10 resides in the core network and facilitates communication between access networks and the Internet using communication interface circuit 18. The communication interface circuit 18 includes circuitry for communicating with other nodes in the core network, radio nodes, and/or other types of nodes in the network for the purposes of providing data and cellular communication services. According to various embodiments, cellular communication services may be operated according to any one or more of the 3GPP cellular standards, GSM, GPRS, WCDMA, HSDPA, LTE and LTE-Advanced.

The network node 10 also includes one or more processing circuits 12 that are operatively associated with the communication interface circuit 18. For ease of discussion, the one or more processing circuits 12 are referred to hereafter as “the processing circuit 12”. The processing circuit 12 comprises one or more digital processors 22, e.g., one or more microprocessors, microcontrollers, Digital Signal Processors (DSPs), Field Programmable Gate Arrays (FPGAs), Complex Programmable Logic Devices (CPLDs), Application Specific Integrated Circuits (ASICs), or any mix thereof. More generally, the processing circuit 12 may comprise fixed circuitry, or programmable circuitry that is specially configured via the execution of program instructions implementing the functionality taught herein, or may comprise some mix of fixed and programmed circuitry. The processor 22 may be multi-core having two or more processor cores utilized for enhanced performance, reduced power consumption, and more efficient simultaneous processing of multiple tasks.

The processing circuit 12 also includes a memory 24. The memory 24, in some embodiments, stores one or more computer programs 26 and, optionally, configuration data 28. The memory 24 provides non-transitory storage for the computer program 26 and it may comprise one or more types of computer-readable media, such as disk storage, solid-state memory storage, or any mix thereof. By way of non-limiting example, the memory 24 comprises any one or more of SRAM, DRAM, EEPROM, and FLASH memory, which may be in the processing circuit 12 and/or separate from the processing circuit 12.

In general, the memory 24 comprises one or more types of computer-readable storage media providing non-transitory storage of the computer program 26 and any configuration data 28 used by the network node 10. Here, “non-transitory” means permanent, semi-permanent, or at least temporarily persistent storage and encompasses both long-term storage in non-volatile memory and storage in working memory, e.g., for program execution.

The processor 22 of the processing circuit 12 may execute a computer program 26 stored in the memory 24 that configures the processor 22 to determine there is a loss of user context information for one or more user equipments and signal, via the communication interface 18, to radio base stations connected to the network node 10 to notify the one or more user equipments of the loss of user context information in broadcast system information. This structure and functionality may be referred to as loss notification circuitry 20 in the processing circuit 12.

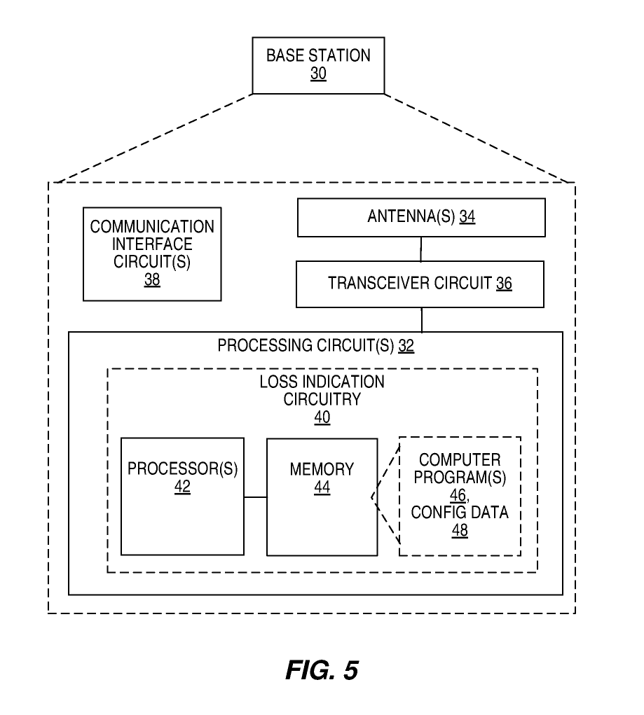

FIG. 5 illustrates a diagram of a radio base station 30, according to some embodiments. The base station 30 provides an air interface to wireless devices, e.g., an LTE air interface for downlink transmission and uplink reception, which is implemented via antennas 34 and a transceiver circuit 36. The transceiver circuit 36 may include transmitter circuits, receiver circuits, and associated control circuits that are collectively configured to transmit and receive signals according to a radio access technology, for the purposes of providing cellular communication services. According to various embodiments, cellular communication services may be operated according to any one or more of the 3GPP cellular standards, GSM, general packet radio service (GPRS), wideband code division multiple access (WCDMA), high-speed downlink packet access (HSDPA), LTE and LTE-Advanced. The base station 30 may also include a communication interface circuit 38 for communicating with nodes in the core network such as the network node 10, other peer radio nodes, and/or other types of nodes in the network. The base station 30 may be, for example, an eNodeB.

The base station 30 also includes one or more processing circuits 32 that are operatively associated with the communication interface circuit 38 and transceiver circuit 36. The processing circuit 32 comprises one or more digital processors 42, e.g., one or more microprocessors, microcontrollers, DSPs, FPGAs, CPLDs, ASICs, or any mix thereof. More generally, the processing circuit 32 may comprise fixed circuitry, or programmable circuitry that is specially configured via the execution of program instructions implementing the functionality taught herein, or may comprise some mix of fixed and programmed circuitry. The processor 32 may be multi-core.

The processing circuit 32 also includes a memory 44. The memory 44, in some embodiments, stores one or more computer programs 46 and, optionally, configuration data 48. The memory 44 provides non-transitory storage for the computer program 46 and it may comprise one or more types of computer-readable media, such as disk storage, solid-state memory storage, or any mix thereof. By way of non-limiting example, the memory 44 comprises any one or more of SRAM, DRAM, EEPROM, and FLASH memory, which may be in the processing circuit 32 and/or separate from the processing circuit 32. In general, the memory 44 comprises one or more types of computer-readable storage media providing non-transitory storage of the computer program 46 and any configuration data 48 used by the base station 30.

The processor 42 may execute a computer program 46 stored in the memory 44 that configures the processor 42 to determine that the network node 10 has lost user context information for one or more user equipments registered to the network node 10, and, in response to the determination, transmit, via the transceiver circuit 36, an information element indicating the loss of user context information in broadcast system information. This structure and functionality may be referred to as loss indication circuitry 40 in the processing circuit 52.

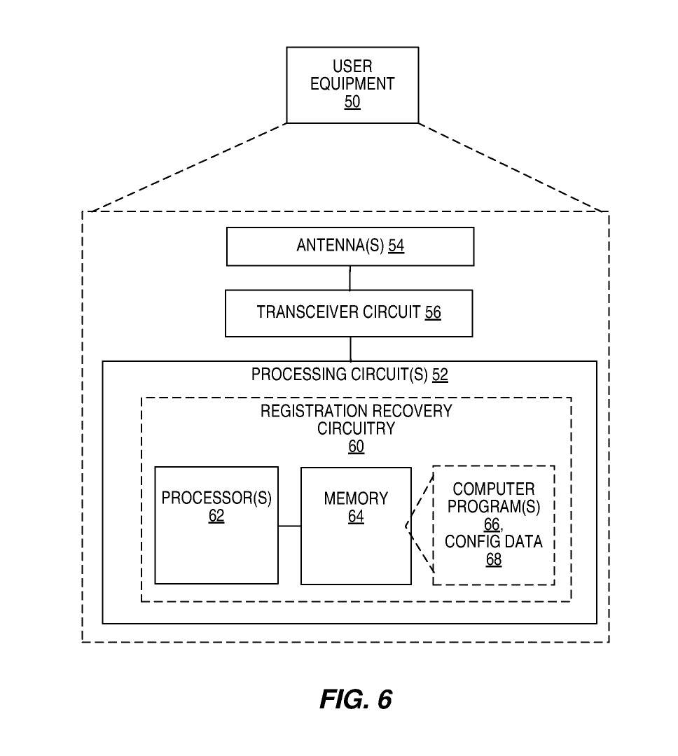

FIG. 6 illustrates a diagram of a wireless device, such as a user equipment 50, according to some embodiments. To ease explanation, the user equipment 50 may also be considered to represent any wireless devices that perform machine to machine (M2M) communications or machine-type communication (MTC). The user equipment 50 communicates with a radio node or base station, such as base station 30, via antennas 54 and a transceiver circuit 56. The transceiver circuit 56 may include transmitter circuits, receiver circuits, and associated control circuits that are collectively configured to transmit and receive signals according to a radio access technology, for the purposes of providing cellular communication services. According to various embodiments, cellular communication services may be operated according to any one or more of the 3GPP cellular standards, GSM, GPRS, WCDMA, HSDPA, LTE and LTE-Advanced.

The user equipment 50 also includes one or more processing circuits 52 that are operatively associated with the radio transceiver circuit 56. The processing circuit 52 comprises one or more digital processing circuits, e.g., one or more microprocessors, microcontrollers, DSPs, FPGAs, CPLDs, ASICs, or any mix thereof. More generally, the processing circuit 52 may comprise fixed circuitry, or programmable circuitry that is specially adapted via the execution of program instructions implementing the functionality taught herein, or may comprise some mix of fixed and programmed circuitry. The processing circuit 52 may be multi-core.

The processing circuit 52 also includes a memory 64. The memory 64, in some embodiments, stores one or more computer programs 66 and, optionally, configuration data 68. The memory 64 provides non-transitory storage for the computer program 66 and it may comprise one or more types of computer-readable media, such as disk storage, solid-state memory storage, or any mix thereof. By way of non-limiting example, the memory 64 comprises any one or more of SRAM, DRAM, EEPROM, and FLASH memory, which may be in the processing circuit 52 and/or separate from processing circuit 52. In general, the memory 64 comprises one or more types of computer-readable storage media providing non-transitory storage of the computer program 66 and any configuration data 68 used by the user equipment 50.

The processor 62 of the processor circuit 52 may execute a computer program 66 stored in the memory 64 that configures the processor 62 to receive an information element in broadcast system information from a radio base station, such as base station 30 connected to the network node 10, the information element indicating the network node 10 has lost user context information. The processing circuit 52 is also configured to compare the network node 10 indicated by the information element to information stored on the user equipment 50 that identifies the network node to which the user equipment 50 is registered. Responsive to a determination that the network node 10 indicated by the information element matches the network node in the stored information, the processing circuit 52 initiates detachment and reattachment of the user equipment 50 to the network node 10. The user equipment 50 may also perform any other procedure to recover registration upon receiving one or more information elements in the broadcast system information. This functionality may be performed by registration recovery circuitry 60 in processing circuit 52.

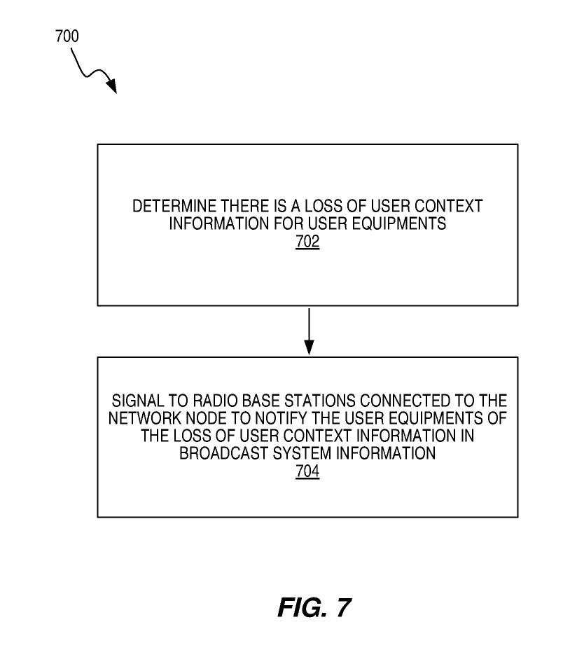

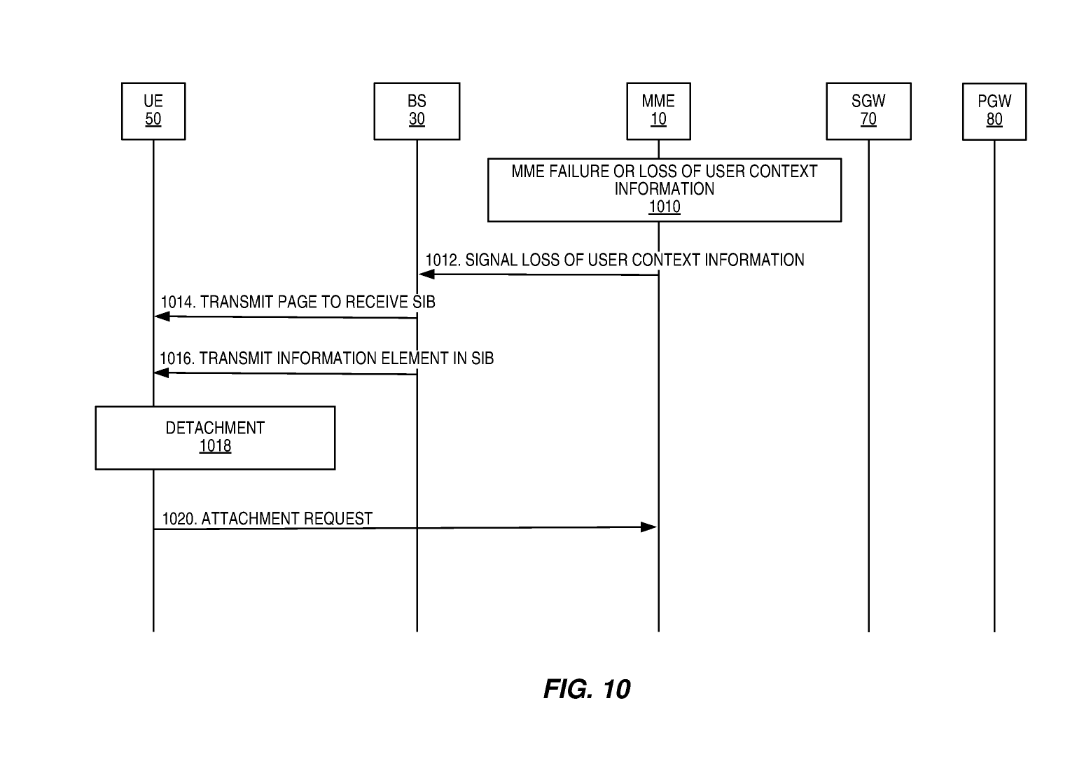

FIG. 10 illustrates an example overview of the registration recovery of the user equipment 50 upon a loss of user context information by the network node 10 (block 1010), shown as MME 10 in this example. The network may also include a serving gateway 70 and a packet data network gateway 80. FIG. 10 will be used as context to explain methods 700-900 of FIGS. 7-9.

Process 1012 of FIG. 10 shows the MME 10 signaling loss of user context information to the base station 30. The processing circuit 12 of the MME 10 is configured to perform a method, such as method 700 of FIG. 7. The method 700 includes determining there is a loss of user context information for user equipments like the user equipment 50 (block 702). The MME 10 then signals to the base station 30 connected to the MME 10 to notify user equipments, including the user equipment 50, of the loss of user context information in broadcast system information (block 704). The user context information lost by the MME 10 may include one or more temporary mobile subscriber identifiers, one or more tracking area identifiers, and/or DRX cycle length information for the user equipments 50.

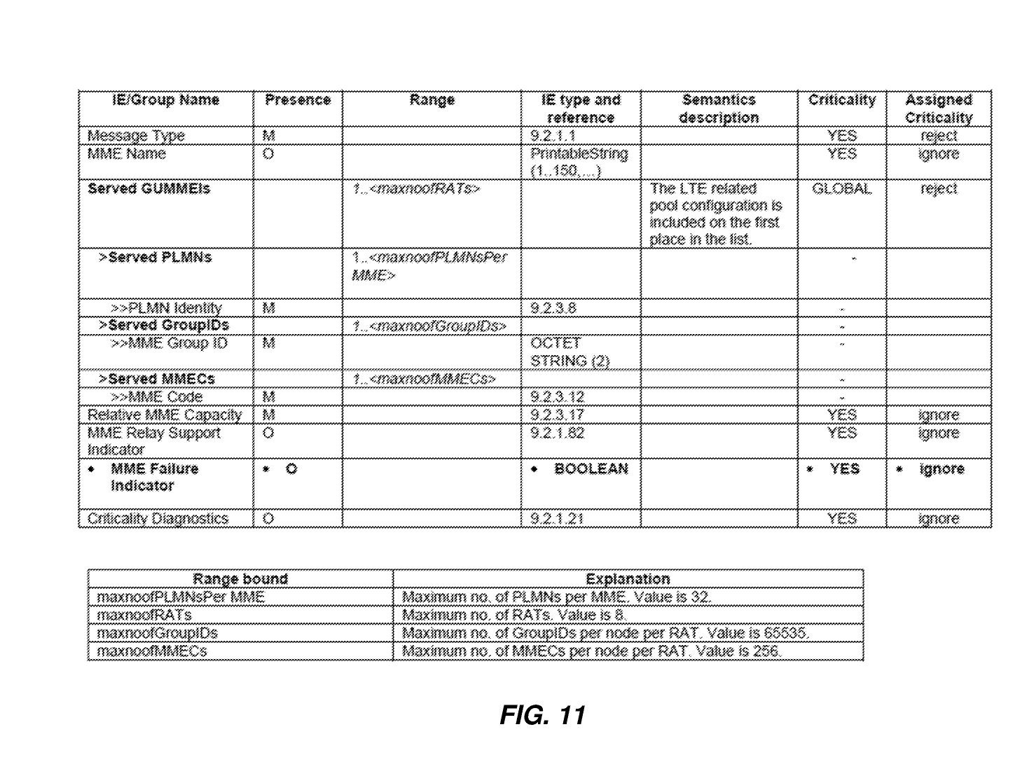

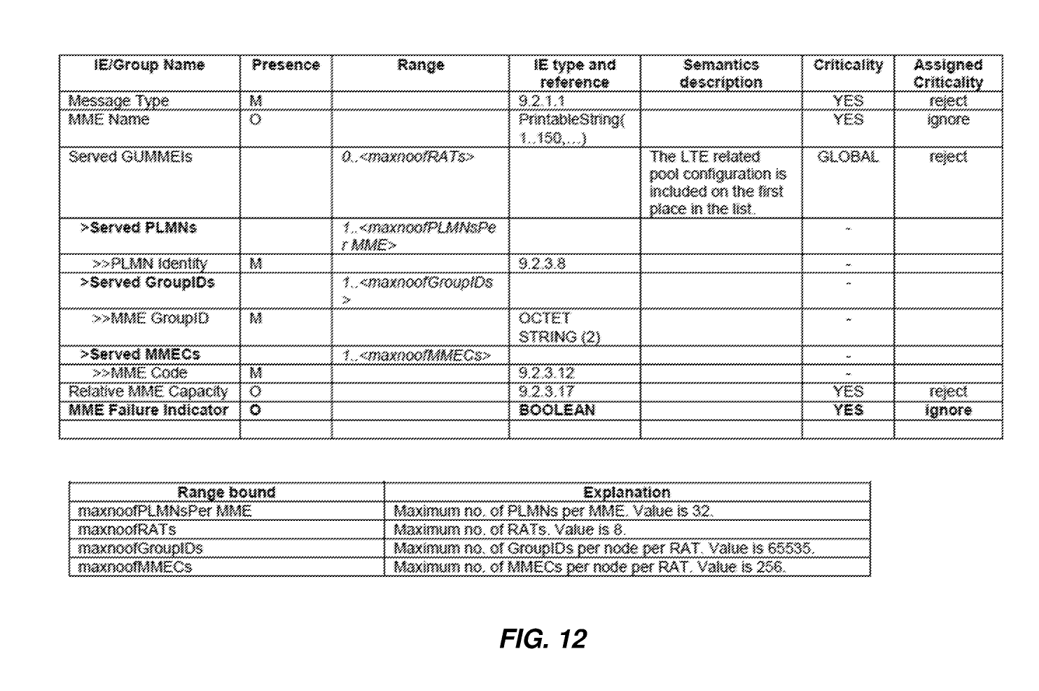

In some cases, the MME 10 signals an information element indicating the loss of user context information during an S1 management procedure. For example, the information element is transmitted in an S1 SETUP RESPONSE message and/or an MME CONFIGURATION UPDATE message. FIG. 11 shows a suggested change to the S1 SETUP RESPONSE. This message is sent by the MME 10 to transfer information for a Transport Network Layer (TNL) association. The direction is from the MME 10 to an eNB. FIG. 12 shows suggested changes to the MME CONFIGURATION UPDATE. This message is sent by the MME 10 to transfer updated information for a TNL association. The direction is from the MME 10 to an eNB.

At process 1014, the base station 30 transmits a page to user equipments to receive system broadcast information (SIB). The page may be sent to all user equipments in all cells of the base station 30.

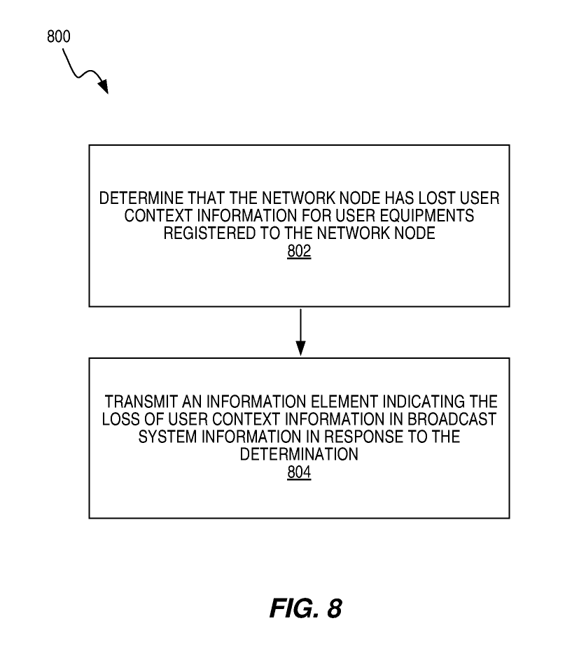

At process 1016, an information element indicating the MME 10 lost user context information is transmitted to user equipments in broadcast system information. The processing circuit 32 of the base station 30 is configured to perform a method, such as method 800 of FIG. 8. The method 800 includes determining that the MME 10 has lost user context information for one or more user equipments registered to the MME 10 (block 802). This determination may be made in response to receiving signaling or an information element from the MME 10 indicating the loss of user context information.

In response to the determination, the base station 30 transmits an information element indicating the loss of user context information in broadcast system information (block 804). The information element may identify the MME 10. For example, an information element includes one or more Global Unique Mobility Management Entity Identifiers (GUMMEIs) of the MME, one or more MME Identifiers (MMEIs) of the MME, one or more MME Group Identities (MMEGIs), and/or one or more MME codes (MMECs) of the MME.

The user equipment 50 receives the page notifying the user equipment 50 to receive the broadcast system information and initiates reception of the broadcast system information responsive to receiving the page. Alternatively, rather than receiving the page, the user equipment 50 receives the information element in broadcast system information during a periodic monitoring of the broadcast system information. This may involve autonomously starting to receive broadcast system information during periodic intervals.

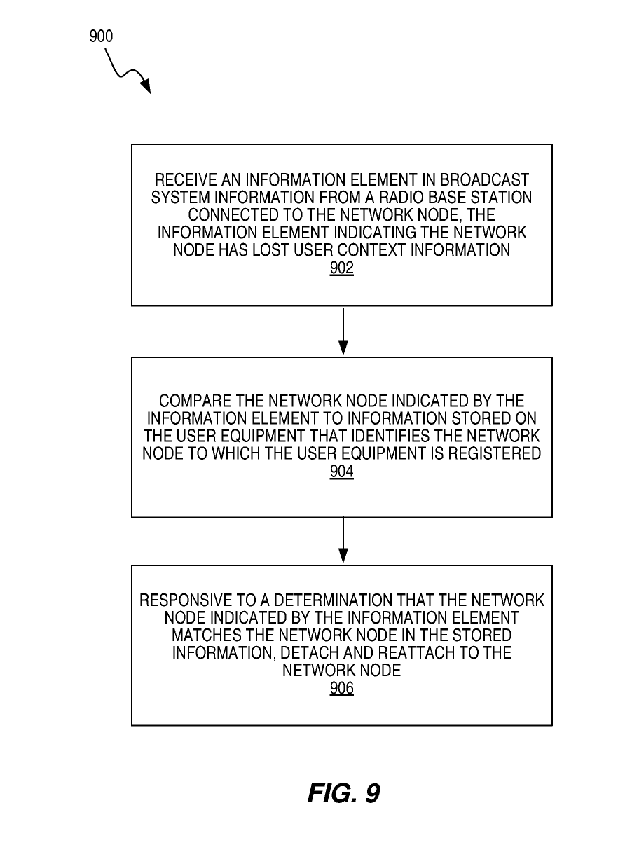

The processing circuit 52 of the user equipment 50 is configured to perform a method, such as method 900 of FIG. 9. The method 900 includes receiving an information element in broadcast system information from the base station 30 connected to the MME 10, the information element indicating the MME 10 has lost user context information (block 902). The method 900 also includes comparing the MME 10 indicated by the information element to information stored on the user equipment 50 that identifies the network node or MME to which the user equipment is registered (block 904).

The method 900 further includes, responsive to a determination that the MME 10 indicated by the information element matches the network node in the stored information, initiating detachment (process 1018) and reattachment (attachment request 1020) to the network node (block 906). The MME 10 may also recreate new user context information for the user equipment 50 or other user equipments that reattach to the MME 10.

To prevent unnecessary detachment and reattachment, the user equipment 50, according to some embodiments, compares a stored counter value, previously received from the network and representing, directly or indirectly, a number of times the MME 10 has lost user context information, to a loss counter value indicated in the broadcast system information. The processing circuit 52 of the user equipment 50 controls the user equipment to detach and reattach to the MME 10 based on whether the stored counter value matches the loss counter value. For example, when the values match, detachment and reattachment are not performed. If the values are different, then detachment and reattachment are performed. The MME 10 may increment a counter value upon a loss of user context information by the MME 10 and transmit the counter value. While the MME 10 is used as an example network node, the methods are not limited to MMES.

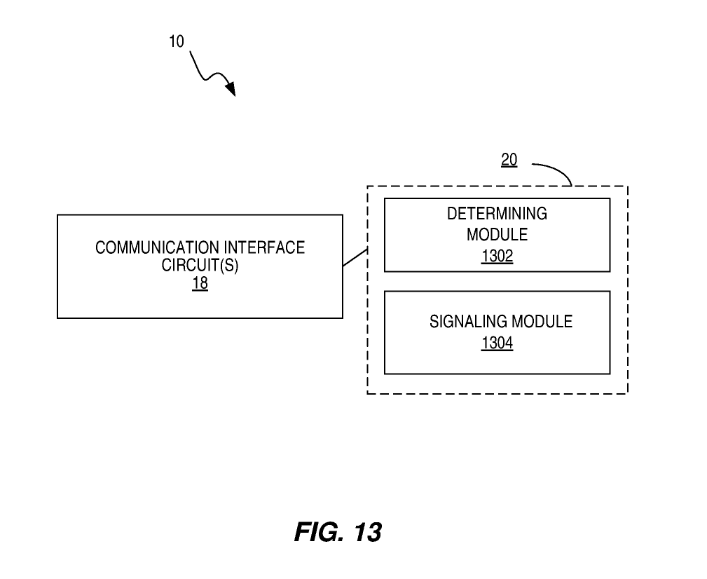

FIG. 13 illustrates an example functional module or circuit architecture as may be implemented in the network node 10, e.g., based on the processing circuitry 20. The illustrated embodiment at least functionally includes a determining module 1302 for determining there is a loss of user context information for one or more user equipments. The embodiment also includes a signaling module 1304 for signaling to radio base stations connected to the network node to notify the one or more user equipments of the loss of user context information in broadcast system information.

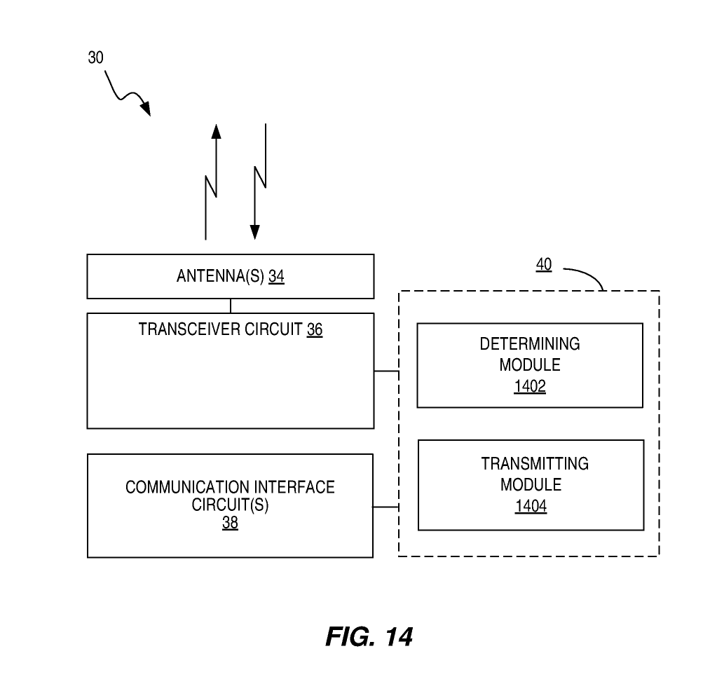

FIG. 14 illustrates an example functional module or circuit architecture as may be implemented in the base station 30, e.g., based on the processing circuitry 40. The illustrated embodiment at least functionally includes a determining module 1402 for determining that a network node has lost user context information for one or more user equipments registered to the network node. The embodiment also includes a transmitting module 1404 for, in response to said determining, transmitting an information element indicating the loss of user context information in broadcast system information.

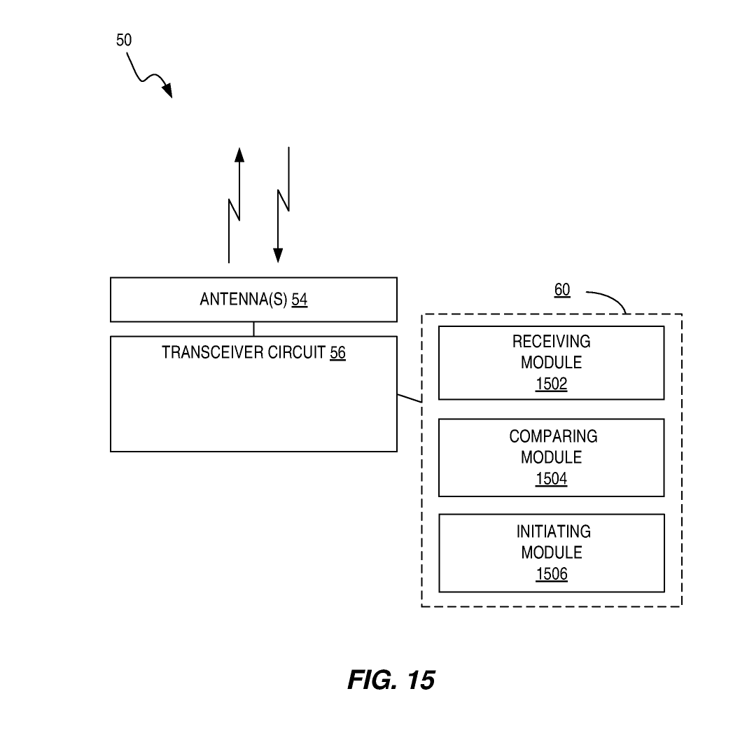

FIG. 15 illustrates an example functional module or circuit architecture as may be implemented in the user equipment 50, e.g., based on the processing circuitry 60. The illustrated embodiment at least functionally includes a receiving module 1502 for receiving an information element in broadcast system information from a radio base station connected to a network node, the information element indicating the network node has lost user context information. The embodiment also includes a comparing module 1504 for comparing the network node indicated by the information element to information stored on the user equipment that identifies the network node to which the user equipment is registered. The embodiment also includes a signaling module 1506 for, responsive to a determination that the network node indicated by the information element matches the network node in the stored information, detaching and reattaching to the network node.

Notably, modifications and other embodiments of the disclosed invention(s) will come to mind to one skilled in the art having the benefit of the teachings presented in the foregoing descriptions and the associated drawings. Therefore, it is to be understood that the invention(s) is/are not to be limited to the specific embodiments disclosed and that modifications and other embodiments are intended to be included within the scope of this disclosure. Although specific terms may be employed herein, they are used in a generic and descriptive sense only and not for purposes of limitation.

1-43. (canceled)

44. A method, in a radio base station connected to a network node in a wireless communication network, for indicating a loss of user context information stored by the network node, the method comprising:
determining that the network node has lost user context information for one or more user equipments registered to the network node; and,
in response to said determining, transmitting an information element indicating the loss of user context information in broadcast system information.

45. The method of claim 44, wherein the user context information lost by the network node comprises one or more temporary mobile subscriber identifiers, one or more tracking area identifiers, and/or discontinuous reception (DRX) cycle length information for the one or more user equipments.

46. The method of claim 44, further comprising transmitting a paging message that indicates that all user equipments of the cells are to receive broadcast system information.

47. The method of claim 44, wherein determining that the network node has lost user context information comprises receiving an information element from the network node indicating that the loss of user context information has occurred.

48. The method of claim 44, wherein the information element comprises an identifier of the network node.

49. A method, in a user equipment registered to a network node in a wireless communication network, for reattaching to the network node upon loss of user context information stored by the network node, the method comprising:
receiving an information element in broadcast system information from a radio base station connected to the network node, the information element indicating the network node has lost user context information;
comparing the network node indicated by the information element to information stored on the user equipment that identifies the network node to which the user equipment is registered; and
responsive to a determination that the network node indicated by the information element matches the network node in the stored information, detaching and reattaching to the network node.

50. The method of claim 49, further comprising:
receiving a page notifying the user equipment to receive the broadcast system information; and
initiating reception of the broadcast system information responsive to receiving the page.

51. The method of claim 49, wherein the information element is received during a periodic monitoring of the broadcast system information.

52. A method, in a network node storing user context information for user equipments for which the network node is registered, for recreating new user context information upon a loss of user context information, comprising:
determining there is a loss of user context information for one or more user equipments; and
signaling to radio base stations connected to the network node to notify the one or more user equipments of the loss of user context information in broadcast system information.

53. A radio base station connected to a network node in a wireless communication network and configured to indicate a loss of user context information stored by the network node, the radio base station comprising:
a transceiver circuit; and
a processing circuit operatively connected to the transceiver circuit and configured to:
determine that the network node has lost user context information for one or more user equipments registered to the network node; and
in response to the determination, transmit, via the transceiver circuit, an information element indicating the loss of user context information in broadcast system information.

54. The radio base station of claim 53, wherein the user context information lost by the network node comprises one or more temporary mobile subscriber identifiers, one or more tracking area identifiers, and/or discontinuous reception (DRX) cycle length information for the one or more user equipments.

55. The radio base station of claim 53, wherein the processing circuit is configured to transmit a page message, via the transceiver circuit, that indicates that all user equipments of the cells are to receive broadcast system information.

56. The radio base station of claim 53, wherein the processing circuit is configured to determine that the network node has lost user context information by receiving, via the transceiver circuit, an information element from the network node indicating that the loss of user context information has occurred.

57. The radio base station of claim 53, wherein the information element comprises an identifier of the network node.

58. A user equipment, registered to a network node in a wireless communication network and configured to reattach to the network node upon loss of user context information stored by the network node, the user equipment comprising:
a transceiver circuit; and
a processing circuit operatively connected to the transceiver circuit and configured to:
receive an information element in broadcast system information from a radio base station connected to the network node, the information element indicating the network node has lost user context information;
compare the network node indicated by the information element to information stored on the user equipment that identifies the network node to which the user equipment is registered; and
responsive to a determination that the network node indicated by the information element matches the network node in the stored information, initiate detachment and reattachment to the network node.

59. The user equipment of claim 58, wherein the processing circuit is configured to:
receive, via the transceiver circuit, a page notifying the user equipment to receive the broadcast system information; and
initiate reception of the broadcast system information responsive to receiving the page.

60. The user equipment of claim 58, wherein the information element is received during a periodic monitoring of the broadcast system information.

61. A network node storing user context information for user equipments for which the network node is registered and configured to recreate new user context information upon a loss of user context information, the network node comprising:
a communication interface circuit; and
a processing circuit operatively connected to the communication interface circuit and configured to:
determine there is a loss of user context information for one or more user equipments; and
signal, via the communication interface circuit, to radio base stations connected to the network node to notify the one or more user equipments of the loss of user context information in broadcast system information.
